(19) United States
(12) Patent Application Publication
(10) Pub. No.: US 2009/0274468 A1
(43) Pub. Date: Nov. 5, 2009

(54) Transceiver module with releasing mechanism

(75) Inventors: Xue-Liang Zhang, Kunshan (CN); Qing-Man Zhu, Kunshan (CN); Xiao-Guo Zhang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/387,288

(22) Filed: Apr. 30, 2009

(30) Foreign Application Priority Data
Apr. 30, 2008 (CN) 200820035880.6

(51) Int. Cl. H04B 10/00

(52) U.S. Cl. 398/139

(57) ABSTRACT

A pluggable transceiver module assembly includes a cage (4) having a latch (41) formed thereon, and a pluggable transceiver module (1) for assembling to the cage. The pluggable transceiver module (1) includes a housing (10) having a latching portion (141) engageable with the latch, an actuator (31) and a pivot (34) slidably mounted on the housing, a lever (32) and a spring member (33). The lever engages with the pivot and manipulates to drive the pivot and therefore the actuator to operate the latch. The spring member has a first connecting portion (331) coupled with the lever and a second connecting portion (334) assembled to the housing. The first connecting portion exerts a restoring force to the actuator.

### BACKGROUND OF THE INVENTION

1. Field of the Invention

The present invention relates generally to a pluggable transceiver module, such as a transceiver module for high speed communication, and more specifically, to a pluggable transceiver module having releasing mechanism for separating such modules from their receptacles.

2. Description of the Prior Art

A pluggable transceiver module is disclosed in U.S. Pat. No. 6,767,143 issued to Huang on Jul. 27, 2004. The pluggable transceiver module is retained in a complementary cage having a latch arranged thereon. The pluggable transceiver module includes a housing and a releasing mechanism disposed on the housing. The housing has a latching portion arranged thereon for engaging with the latch of the cage. The releasing mechanism includes an actuator slidably arranged on the housing and a lever rotatably assembled on the housing for moving the actuator between an initial position and a final position. When the lever moves to drive the actuator to the final position, the actuator disengages the latching portion from the latch of the cage and is ready for unplugging therefrom.

When the module is inserted into the cage, the actuator may be positioned in the final position under an undesirable movement of the actuator. That would result in breaking the engagement between the first and latching portions. When the pluggable transceiver module is released from the cage, it is very much likely that the lever could not exert a driving force for moving the actuator from the final position back toward the initial position.

Hence, an improved pluggable transceiver module with releasing mechanism is needed to solve the above problem.

### BRIEF SUMMARY OF THE INVENTION

An object of the present invention is to provide a pluggable transceiver module comprising a releasing mechanism having a spring member for preventing undesirable movement of an actuator.

Another object of the present invention is to provide a pluggable transceiver module comprising a releasing mechanism having a spring member for providing a restoring force for moving an actuator from a final position back toward an initial position.

In order to achieve the object set forth, a pluggable transceiver module assembly includes a cage having a latch formed thereon, and a pluggable transceiver module for assembling to the cage. The pluggable transceiver module includes a housing having a latching portion engageable with the latch, an actuator and a pivot slidably mounted on the housing, a lever and a spring member. The lever engages with the pivot and manipulates to drive the pivot and therefore the actuator to operate the latch. The spring member has a first connecting portion coupled with the lever and a second connecting portion assembled to the housing. The first connecting portion exerts a restoring force to the actuator.

When assemble the module to the cage, the spring member exerts a resilient force to the lever for preventing undesirable movement of the actuator. Therefore, the actuator is securely kept in an initial position, and the pluggable transceiver module could be easily assembled into the cage. When the pluggable transceiver module is to be released from the cage, the spring member exerts a restoring force to the lever for moving the actuator from a final position back toward the initial position. Therefore, the actuator returns to the initial position.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is an assembled perspective view of a pluggable transceiver module in accordance with the present invention;

FIG. 2 is an exploded perspective view of the pluggable transceiver module as shown in FIG. 1;

FIG. 3 is another exploded perspective view of the pluggable transceiver module as shown in FIG. 1, taken from another aspect;

FIG. 4 is an assembled perspective view of the pluggable transceiver module inserted in a cage with an actuator positioned in an initial position; and

FIG. 5 is a perspective view similar to FIG. 4, taken from another aspect;

FIG. 6 is an assembled perspective view of the pluggable transceiver module inserted in a cage with the actuator positioned in a final position; and

FIG. 7 is a perspective view similar to FIG. 5, taken from another aspect.

### DETAILED DESCRIPTION OF THE INVENTION

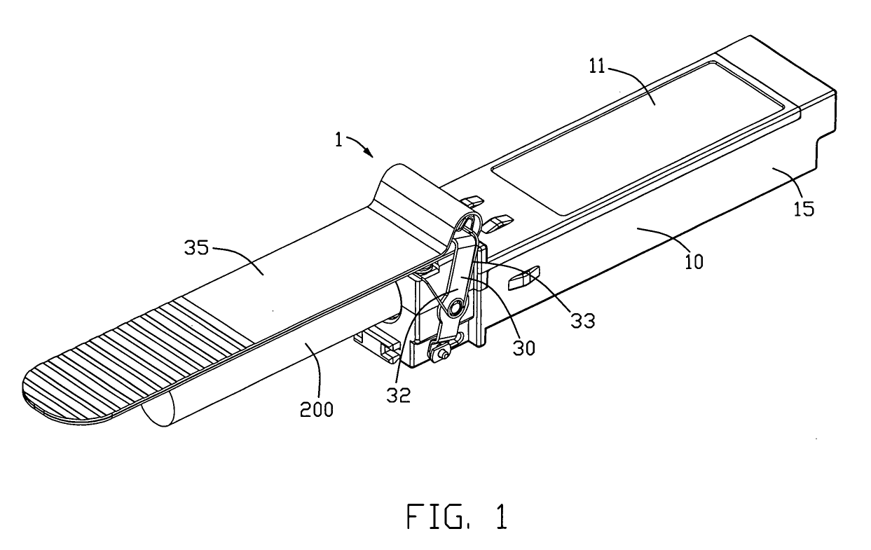

Reference will now be made to the drawing figures to describe the present invention in detail. Referring to FIGS. 1-7, a pluggable transceiver module 1 in accordance with a preferred embodiment of the present invention is adapted to be retained in a cage 4. The pluggable transceiver module 1 includes a housing 10, a printed circuited board 20 received in the housing 10 and having a plurality of signal transmitting and receiving components (not shown) disposed thereon, and a releasing mechanism 30 assembled to the housing 10. The pluggable transceiver module 1 further includes a cable 200 electrically connected with the printed circuit board 20. The cage 4 includes a latch 41 formed thereon.

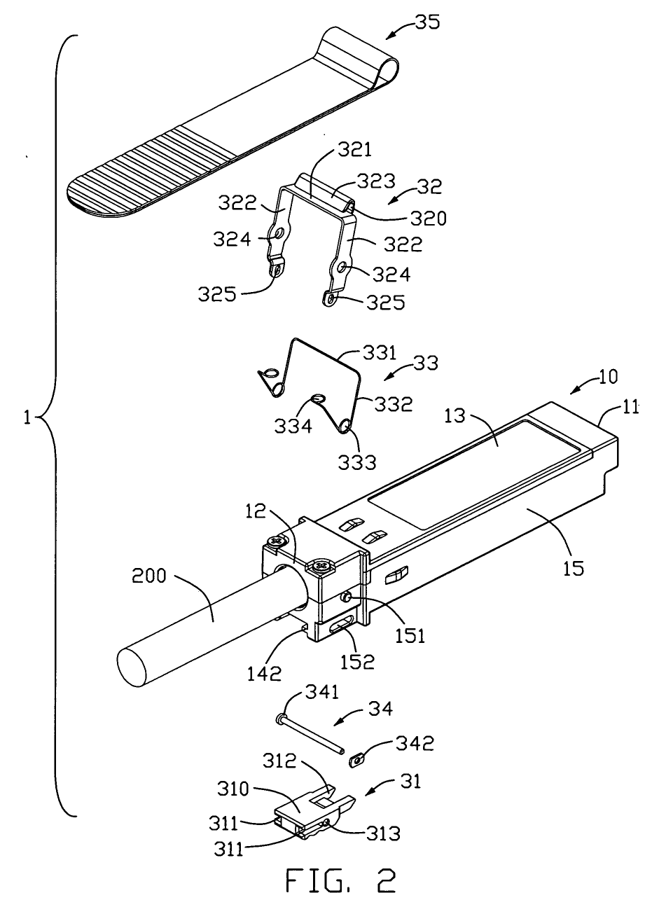

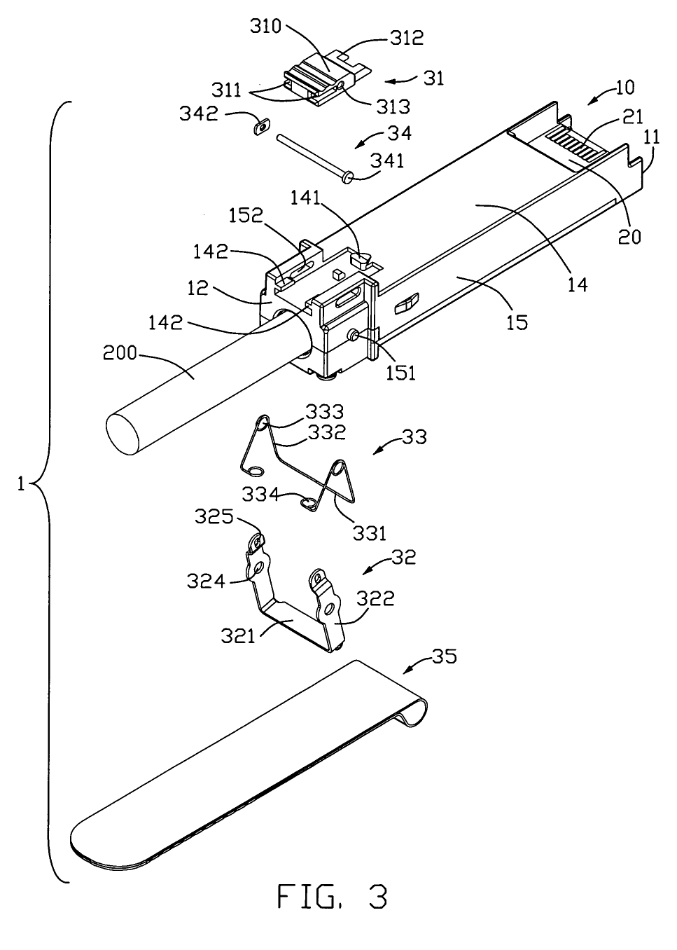

Referring to FIGS. 2 and 3, the housing 10 has a longitudinal body having a front end 11 and a rear end 12. The printed circuit board 20 has a plurality of conductive pads 21 exposed adjacent to the front end 11. The cable 200 extends outwardly from the rear end 12. The housing 10 has a top wall 13, a bottom wall 14 and two opposite lateral walls 15. The bottom wall 14 has a latching portion 141 disposed adjacent to the rear end 12 of the housing 10. In this embodiment of the present invention, the latching portion 141 is a protruding portion 141 formed on the bottom wall 14. The bottom wall 14 also has a pair of guiding rails 142 formed thereon. The guiding rails 142 project inwardly toward each other. Each lateral wall 15 has a projecting post 151 formed thereon and a horizontal guiding slot 152 defined below the projecting post 151.

The releasing mechanism 30 includes an actuator 31, a U-shaped lever 32, a spring member 33, a pivot 34 and a pull tab 35.

The actuator 31 is slidably mounted on the bottom wall 14 of the housing 10. The actuator 31 has a base 310 and a pair of horizontal guiding grooves 311 defined at opposite sides of the base 310. The base 310 has a pair of wedges 312 formed on a front end thereof, and a through hole 313 defined therethrough.

The U-shaped lever 32 includes a bridging section 321, and a pair of arm sections 322 extending from opposite ends of the bridging section 321. The U-shaped lever 32 has a crimp portion 323 extends upwardly from an edge of the bridging section 321 and defines a passage 320. Each arm section 322 has a pivot hole 324 defined in middle portion thereof, and a latch arm guiding hole 325 defined below the pivot hole 324 and adjacent to free end of the arm section 322.

The spring member 33 has a pair of first connecting portions 331 received in the passage 320 of the crimp portion 323, a second connecting portion 334 mounted on the top wall 13 of the housing 10, and a pair of V-shaped elastic arms 332 disposed between the first connecting portions 331 and the second connecting portion 334. The V-shaped arms 332 each has a ring 333 engaged with the projecting post 151 of the housing 10 for increasing the resilient force of the spring member 33. The V-shaped elastic arm 332 has a first connecting portion 334 mounted on the top wall 13 of the housing 10.

The pivot 34 is slidably mounted on the housing. The pivot 34 includes a circular stop 341 formed at one end of the pivot 34 and a washer 342 mounted to an opposite end of the pivot 34.

The pull tab 35 is attached to the bridging section 321 of the U-shaped lever 32 for pivoting the U-shaped lever 32.

In assembly, the actuator 31 is mounted on bottom wall 14 of the housing 10 with the guiding rails 142 moveably received in the guiding grooves 311. The first connecting portion 331 of the spring member 33 is received in the passage 320 of the crimp portion 323. The U-shaped lever 32 is attached to the rear end 12 of the housing 10, with the projecting post 151 of the lateral wall 15 rotatably engaging with the pivot holes 324 of the U-shaped lever 32 and the ring 333 of the spring member 33. The second connecting portion 334 of the spring member 33 is fixed on the top wall 13 of the housing 10. The pivot 34 is inserted through one latch arm guiding hole 325 of the U-shaped lever 32, one horizontal guiding slot 152 of the housing 10, the through hole 313 of the actuator 31, the other horizontal guiding slot 152 of the housing 10, and the other latch arm guiding hole 325 of the U-shaped lever 32. The washer 342 is mounted on the pivot 34 for securely holding the U-shaped lever 32 and the actuator 31 on the housing 10. The U-shaped lever 32 is thus rotatably assembled on the rear end 12 of the housing 10. Then, assembly of the releasing mechanism 30 on the pluggable transceiver module 1 is thus completed.

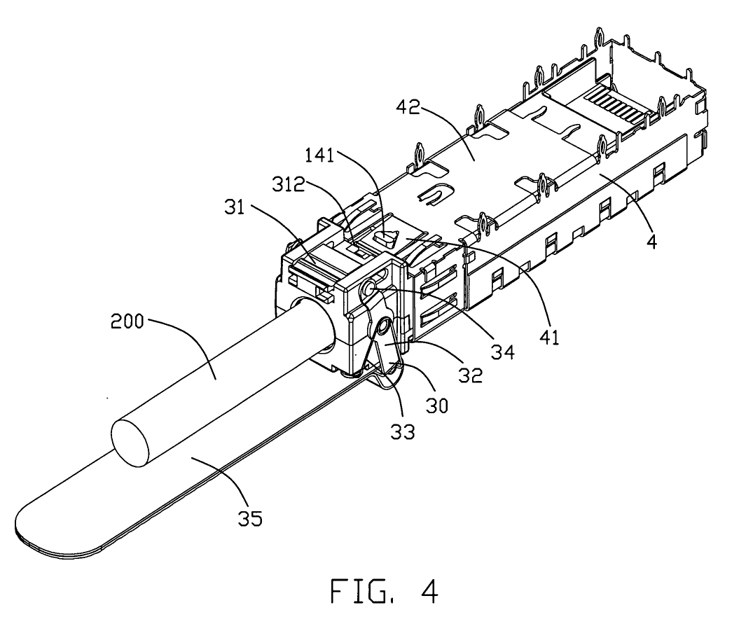

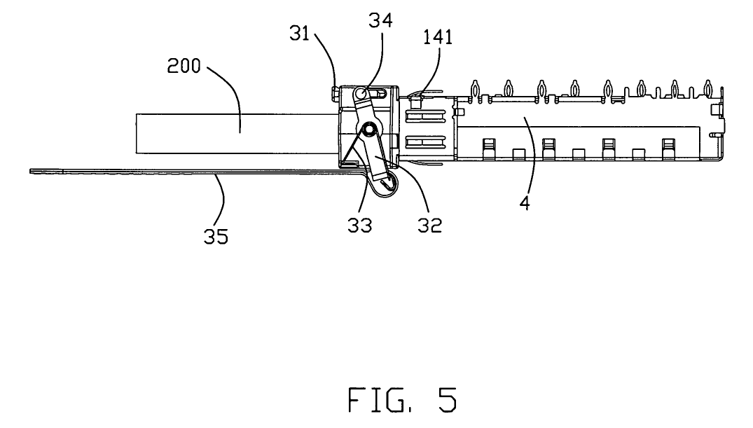

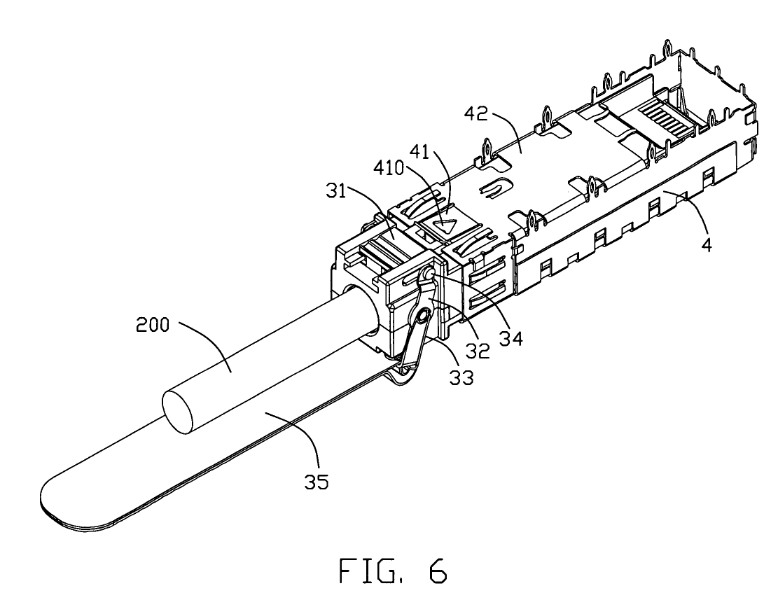

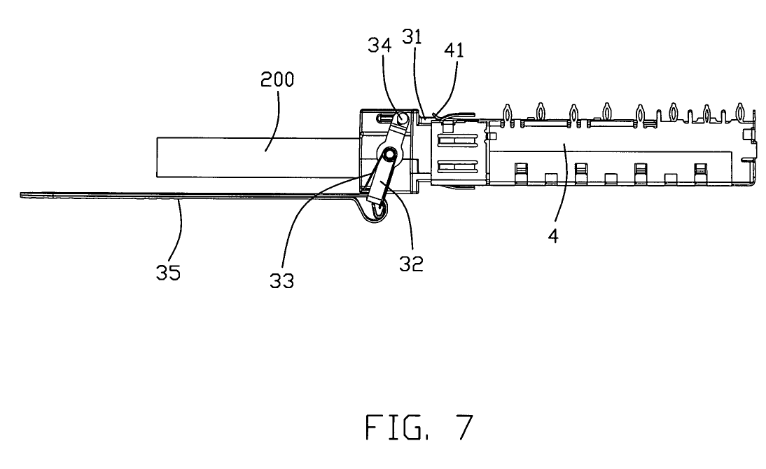

FIGS. 4 and 5 show that the pluggable transceiver module 1 is inserted in the cage 4 with the actuator 31 positioned in the initial position. The latch 41 is formed at a front part of a bottom plate 42 of the cage 4. The latch 41 is a latching tab 41 having a triangular opening 410 defined therein (see FIG. 6). The pluggable transceiver module 1 is mounted into the cage 4 along a forward direction, the spring member 33 exerts a resilient force to the U-shaped lever 32 for urging the actuator 31 secured to the initial position. The latching portion 141 enters into the triangular opening 410 of the latch 41. FIGS. 6 and 7 show that the pluggable transceiver module 1 is inserted in the cage 4 with the actuator 31 positioned in the final position. When the pluggable transceiver module 1 is to be released from the cage 4, a pulling force is exerted by the pull tab 35 onto the crimp portion 323 of the U-shaped lever 32 for pulling away the crimp portion 323 from the rear end 12 of the pluggable transceiver module 1 along a rearward direction. The U-shaped lever 32 thus pushes the actuator 31 forwardly along the guiding rails 142 from the initial position toward the final position. The wedges 312 of the actuator 31 slide forwardly along the latch 41 and pull away the latch 41 from the latching portion 141 of the pluggable transceiver module 1. As a result, the latch 41 is released from the latching portion 141, and the pluggable transceiver module 1 can be readily removed from the cage 4. Under the movement of the U-shaped lever 32, the first connecting portion 331 of the spring member 33 moves toward the second connecting portion 334. When the U-shaped lever 32 is released, the first connecting portion 331 moves away from the second connecting portion 334 of the spring member 33 and exerts a restoring force to the U-shaped lever 32 for moving the actuator 31 toward the initial position. Therefore, the actuator 31 returns to the initial position.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A pluggable transceiver module assembly comprising:
a cage having a latch formed thereon;
a pluggable transceiver module for assembling to the cage, the pluggable transceiver module comprising:
a housing having a latching portion engageable with the latch;
an actuator and a pivot slidably mounted on the housing;
a lever engaged with the pivot and manipulated to drive the pivot and therefore the actuator to operate the latch; and
a spring member having a first connecting portion coupled with the lever and a second connecting portion assembled to the housing, said first connecting portion exerting a restoring force to the actuator.

2. The pluggable transceiver module assembly as claimed in claim 1, wherein said actuator is movable to disengage the latch from the latching portion.

3. The pluggable transceiver module assembly as claimed in claim 2, further comprising a pull tab for pivoting the lever.

4. The pluggable transceiver module assembly as claimed in claim 1, wherein said spring member has a V-shaped elastic arm disposed between the first connecting portion and the second connecting portion.

5. The pluggable transceiver module assembly as claimed in claim 4, wherein said housing has a pair of opposite lateral walls, each lateral wall having a projecting post formed thereon, the spring member having a ring portion formed on the V-shaped elastic arm and engaged with the projecting post.

6. The pluggable transceiver module assembly as claimed in claim 5, wherein said first connecting portion of the spring member rotates toward the second connecting portion around the ring portion when a pulling force is exerted on the lever, and rotates away from the second connecting portion when the pulling force is released from the lever.

7. The pluggable transceiver module assembly as claimed in claim 5, wherein said lever comprises a pair of arm sections and a bridging section connected with the pair of arm sections, each arm section rotatably assembled on the projecting post of the housing.

8. The pluggable transceiver module assembly as claimed in claim 7, wherein said bridging section of the lever has a crimp portion defining a passage for receiving the first connecting portion of the spring member.

9. The pluggable transceiver module assembly as claimed in claim 7, wherein each of said arm sections of the lever has a guiding hole, the housing has a pair of guiding slots defined therein and corresponding to the guiding holes, and the actuator has a through hole defined therethrough, the pivot inserted through one guiding hole of the lever, one guiding slot of the housing, the through hole of the actuator, the other guiding hole of the housing, and the other guiding slot of the lever.

10. The pluggable transceiver module assembly as claimed in claim 1, wherein said latching portion of the housing comprises a protruding portion for entering into an opening of the cage latch.

11. The pluggable transceiver module assembly as claimed in claim 10, wherein said actuator comprises a wedge portion for pushing the latch away from the protruding portion.

12. A pluggable transceiver module comprising:
a housing having a plurality of signal transmitting and receiving components disposed therein;
an actuator and a pivot slidably mounted on the housing;
a lever engaged with the pivot and manipulated to drive the pivot for moving the actuator from an initial position toward an final position when a pulling force is exerted on the lever; and
a spring member having a first connecting portion coupled with the lever and a second connecting portion assembled to the housing, said first connecting portion exerting a restoring force to the actuator for moving the actuator from the final position back toward the initial position when the pulling force is released from the lever.

13. The pluggable transceiver module as claimed in claim 12, wherein said spring member has a V-shaped elastic arm disposed between the first connecting portion and the second connecting portion.

14. The pluggable transceiver module as claimed in claim 13, wherein said housing has a pair of opposite lateral walls, each lateral wall having a projecting post formed thereon, the spring member having a ring portion formed on the V-shaped elastic arm and engaged with the projecting post.

15. The pluggable transceiver module as claimed in claim 14, wherein said first connecting portion of the spring member rotates toward the second connecting portion around the ring portion when the pulling force is exerted on the lever, and rotates away from the second connecting portion when the pulling force is released from the lever.

16. A pluggable transceiver module assembly comprising:
a cage having a latch formed thereon;
a pluggable transceiver module for assembling to the cage, the pluggable transceiver module comprising:
a housing having a latching portion engageable with the latch;
an actuator slidably mounted on the housing;
a lever defining a middle section pivotally mounted to the housing and a distal end pivotally mounted to the actuator so as to be manipulated in a pivotal manner, via a forward pull force upon another distal end of the level, to drive the actuator to release the latch from the latching portion; and
a spring member having a first connecting portion coupled with the lever and a second connecting portion assembled to the housing, said first connecting portion exerting a restoring force to the lever to move rearward said lever.

17. The pluggable transceiver module assembly as claimed in claim 16, wherein said spring is of a torsion type.

18. The pluggable transceiver module assembly as claimed in claim 17, wherein said spring is twisted about an axis aligned with a pivotal axis of said lever of said middle section.
